(19) United States
(12) Patent Application Publication
(10) Pub. No.: US 2006/0026226 A1
(43) Pub. Date: Feb. 2, 2006

(54) Systems and methods for management of parameters in a multi-processor graphics system

(76) Inventors: Jeffrey Joel Walls, Fort Collins, CO (US); Donley Byron Hoffman, Fort Collins, CO (US); Byron Alan Alcom, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/899,865

(22) Filed: Jul. 27, 2004

(51) Int. Cl. G06F 15/16; G09G 5/00; G06F 17/30; G06F 3/00

(52) U.S. Cl. 709/201; 707/1; 345/1.1; 715/733

(57) ABSTRACT

Embodiments of the present invention are broadly directed to novel systems and methods for management of parameters in a multi-processor graphics system. In accordance with one embodiment, a plurality of processors is configured to collectively render a graphics image and a datastore is configured to store parameters that are used to control the rendering of the graphics image. A datastore manager is configured to manage the parameters stored in the datastore, and a plurality of entities are associated with the plurality of systems. Each of the plurality of entities comprises logic for communicating to the datastore manager an interest in being notified if there are changes in at least one of the parameters. Logic associated with the datastore manager notifies interested entities that a change has been made to at least one parameter stored in the datastore.

### BACKGROUND OF THE INVENTION

1. Field of the Invention

The present invention relates to computer systems and, more particularly, to novel systems and methods for management of parameters in a multi-processor graphics system.

2. Discussion of the Related Art

The rendering of three-dimensional computer graphics is a computationally-intensive process. In many high-end applications, three-dimensional computer graphics are rendered using a pool or group of computers, which share the processing responsibilities. In such a system, one computer may be configured to execute at least one application program and communicate graphics data to other computers for processing and rendering. In this regard, a collection of computers may be configured to cooperatively render a graphics image and may receive the graphics data to be rendered from the computer executing the application program.

There are a variety of parameters that are utilized by graphics hardware in the rendering of graphics images. For example, such parameters include the network protocol used to transmit the data from the master node to the render nodes, values to determine data-dependent optimization levels, video format parameters, and general parameters to tune the system on-the-fly. For the rendering to be performed effectively, these parameters should be consistently provided to each of the rendering computers at the same time. This is typically accomplished by providing a configuration file on each of the rendering computers. Through this configuration file, the rendering parameters are supplied to the processes running on the rendering computers.

While this is an effective way of providing parameter information to the various computers, it has certain shortcomings. One significant shortcoming is the inability to effectively update or dynamically change these parameters. That is, if the user or application desires a change in one or more parameters, such a change cannot be effectively made during the execution of the application program, and instead is statically performed, by updating the configuration files of the individual computers.

### SUMMARY

Accordingly, embodiments of the present invention are broadly directed to novel systems and methods for management of parameters in a multi-processor graphics system. In accordance with one embodiment, a plurality of processors is configured to collectively render a graphics image and a datastore is configured to store parameters that are used to control the rendering of the graphics image. A datastore manager is configured to manage the parameters stored in the datastore, and a plurality of entities are associated with the plurality of systems. Each of the plurality of entities comprises logic for communicating to the datastore manager an interest in being notified if there are changes in at least one of the parameters. Logic associated with the datastore manager notifies interested entities that a change has been made to at least one parameter stored in the datastore.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating a computing environment of one embodiment of the present invention.

FIG. 2 is a diagram illustrating certain components associated with a node hosting a datastore and datastore manager, in accordance with one embodiment of the invention.

FIG. 3 is a diagram illustrating certain components of a render node, in accordance with one embodiment of the invention.

FIG. 4 is a flow chart illustrating the top-level functional operation of an embodiment of the invention.

FIG. 5A is a diagram similar to FIG. 2, illustrating an alternative embodiment of the present invention.

FIG. 5B is a diagram similar to FIG. 3, illustrating an alternative embodiment of the invention.

FIG. 6 is a flow chart illustrating the top-level operation of an alternative embodiment of the present invention.

FIG. 7 is a flow chart illustrating yet another embodiment of the present invention.

### DETAILED DESCRIPTION

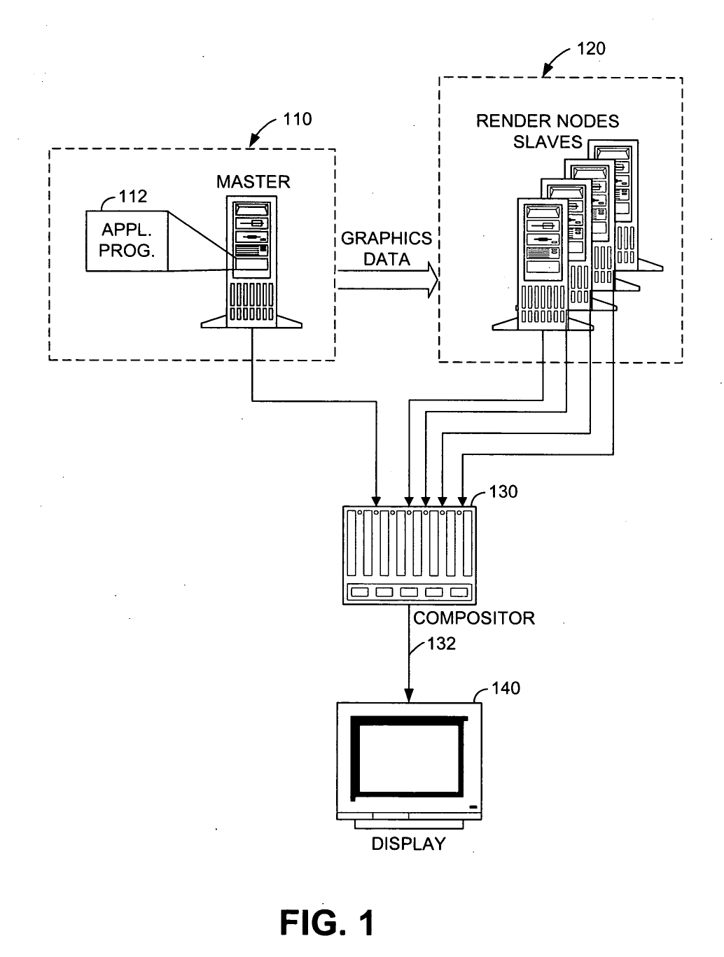

Reference is now made to the drawings, in which FIG. 1 illustrates a computing environment in which one embodiment of the present invention resides and operates. As previously described, many high-end or intensive graphics programs are executed and graphics images are rendered using a plurality of computers (or processors) in combination. There are various ways in which multiple computers may be configured to operate either in parallel or in conjunction to perform a graphics-rendering task. One way is to configure one computer 110 to operate as a master, and configure the remaining plurality of computers 120 to operate as slaves. In the illustrated embodiment, the slave computers 120 is configured to collectively render a three-dimensional graphics image. The rendering among the slave computers 120 may be partitioned in a variety of ways. One way is to partition the screen space into various partitions and have each slave computer render the data associated with its partition. Another way is to partition the graphics data into layers and have each slave 120 render one or more layers.

In the embodiment illustrated in FIG. 1, the master computer 110 executes an application program 112 that involves the rendering of three-dimensional graphics. The control and functionality of the application program 112 are handled by the master computer 110. As well, the master computer 110 handles various two-dimensional graphics rendering that is incidental to the execution of the application program 112. For example, the presentation of drop-down menus or other items of presentation that do not require three-dimensional rendering is performed by the master computer 110. Each of the computers (master computer 110 and each of the slave computers 120) includes a graphics card that outputs a signal for driving a video display 140. Since, however, the content that is rendered by each of the computers must first be combined, the video outputs of each of the computers are delivered to a compositor 130. A compositor 130 operates to combine the content of each of the plurality of input video signals to deliver a single, composite output signal 132 that is used to drive a display device 140.

Consistent with the scope and spirit of the embodiments of the invention described herein, an alternative environment includes multiple displays 140 that are configured to operate as a single logical display. There are a variety of applications in which graphics information is presented over a panel or matrix of displays, to effectively emulate a single, large display. Examples of such systems include: real estate, financial (such as the stock market), control room, large engineering processes, military mapping, telecommunications, etc. Such systems require the output of large amounts of data, which can easily exceed the viewable display capacity of a single, physical monitor (a user could view relevant data only by panning and zooming). The implementation and management of such systems emulating a single display through multiple displays is well known and need not be described herein.

As briefly described above, in three-dimensional computer graphics systems, a wide variety of parameters may be utilized and adjusted to vary or otherwise impact the display output. Such parameters can include video timing parameters, whether “stereo” is active, whether double buffers are synchronized to the vertical blank (when rendering three dimensional images), etc. In many systems, it is desired that the various plurality of computers, that are cooperatively configured to render the display, use these parameters in a consistent fashion. Therefore, if the application program 112 (or user of the application program) causes particular parameters to be changed, it is important (in many applications) that these changes be effectively communicated to all cooperating rendering devices within a very small timing window.

In a system environment such as that of FIG. 1, the computer 110 executing the graphics application program communicates to the cluster of render nodes 120 the relevant data used for carrying out the rendering operations. The structure and content of such data will be known and appreciated by persons skilled in the art, as it is the underlying data specifying primitives, texture, lighting, shading, and other aspects employed for rendering a given graphics image. In one embodiment, such information is communicated by the master 110 to the individual slave computers as appropriate, based upon the partitioned operation of the slave units. In other embodiments, the data is communicated to a defined slave computer that is running a process or program that would further subdivide and allocate the underlying graphics information to individual slave nodes for processing.

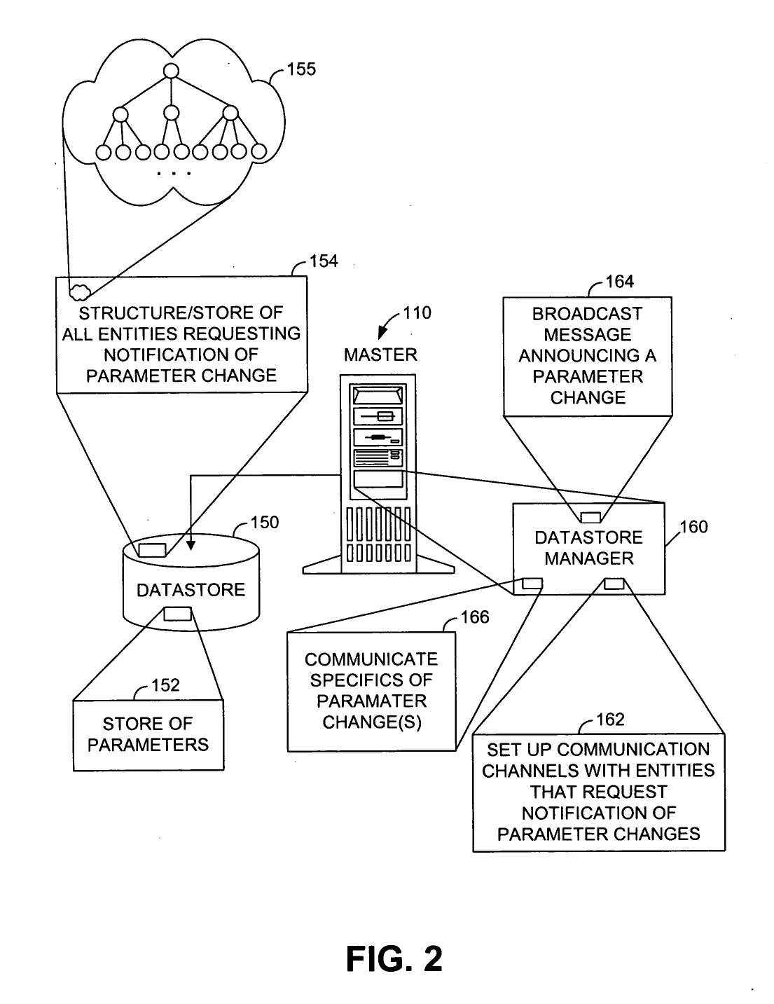

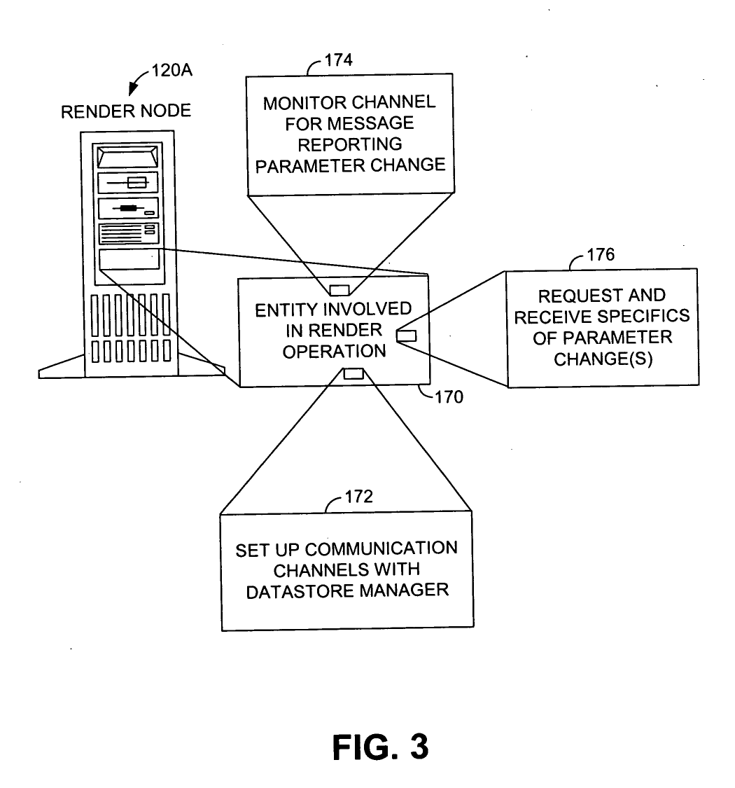

FIGS. 2 and 3 illustrate certain components that are utilized in the system of FIG. 1 for effectively communicating parameters used in the rendering of three-dimensional graphics in accordance with one embodiment of the invention. Reference is first made to FIG. 2, which illustrates components that are implemented on a master node 10 of such embodiment. As summarized above, an embodiment of the present invention involves the utilization of a central datastore 150 that maintains a store 152 of the various parameters that are to be communicated to, and utilized by, the various computers that are cooperating to render a graphics image. In one embodiment, the datastore 150 is provided at the master computer 10 (or in connection with a master processor). In other embodiments, the datastore 150 is provided with one of the render computers (or processors) that are rendering the graphics image, or is provided on a separate computer (or processor) coupled to the network of computers rendering the graphics image. In yet other embodiments, the datastore may be a distributed datastore, distributed across or in connection with a variety of computers.

FIG. 3 illustrates a render node 120A. It should be appreciated that each of the computers in the cluster of render nodes 120 (FIG. 1) have components similar to those illustrated in connection with render node 120A of FIG. 3. Render nodes 120A executes one or more programs that operate to render a portion of a graphics image. In the course of executing such programs, processes or threads are created, which operate to carry out various aspects of the program execution. These processes and threads are generically referred to herein as “entities.” That is, as used herein, the term “entity” includes, but is not limited to, a process or a thread. It should be appreciated that there are a number of entities that may be created and running on a given render node 120A at any given time. FIG. 3, for simplicity and ease of understanding, illustrates only one such entity 170. The other components associated with the entity 170 (illustrated in FIG. 3), as well as the operational aspects of the entity 170 and related components, are similar for other entities created.

As mentioned above, there may be numerous entities running on a given computer or workstation configured as a render node 120A. Indeed, in a system with multiple render nodes cooperating to render a graphics image, at any given time there could be literally hundreds of active entities. After a given entity is created, logic 172 is provided in association with the entity to set up or establish (in cooperation with the master) a communication channel with a datastore manager 160 (FIG. 2). Over this channel, the entity 170 requests that the datastore manager 160 inform the entity 170 whenever changes are made to one or more parameters that are provided in the central store 152 of parameters. Logic 174 is provided in association with the entity 170 for periodically monitoring the channel established by logic 172 for messages received from the datastore manager 160 that report a parameter change. Further, logic 176 is provided in association with the entity 170 for further communicating with the datastore manager 160 to request and receive specifics of parameter changes that have occurred.

Returning to FIG. 2, a datastore manager 160 operates to provide overall controlling management of the datastore 150. The datastore manager 160 also includes logic 162 that operates in response to, or in cooperation with, the logic 170 to establish communication channels with entities that request notification of parameter changes. The datastore manager 160 also includes logic configured to broadcast a message to all entities that have requested to receive notification of parameter changes. In one embodiment, logic 164 broadcasts a short (e.g., one byte) message that is sent over all channels that have been established with the various entities having registered a request for notification that some change has been made to the parameters in the store of parameters 152. Logic 166 is further provided in connection with the datastore manager 160 for communicating specifics of parameter changes to the various entities.

To facilitate the effective communication of parameter changes to requesting entities, the datastore 150 also includes a data structure that efficiently specifies all of the entities that have requested a notification of a parameter change. In one implementation, such a structure is implemented as a linked-list of tuples. Therefore, when the datastore manager 160 detects that a given change has taken place in one or more parameters of the store of parameters 152, then the datastore manager 160 consults the data structure 154 to determine the entities that an appropriate broadcast message should be directed to. Likewise, when a given entity 170 is created and registers with the datastore manager 160 that it be notified of any future changes in parameters (some or all parameters) stored on the datastore 150, the datastore manager 160 causes the data structure 154 to be updated with an appropriate identification of the requesting entity 170 and/or an identification of the communication channel that has been established between the datastore manager 160 and the entity 170.

It should be appreciated that the diagrams of FIGS. 2 and 3 illustrate only certain components that are germane to one embodiment of the present invention. For improved illustration purposes, conventional components and conventional logic utilized for carrying out various graphic operations have been omitted. However, it will be appreciated by persons skilled in the art that additional components and logic elements are implemented in systems carrying out the concepts and teachings of the illustrated embodiment.

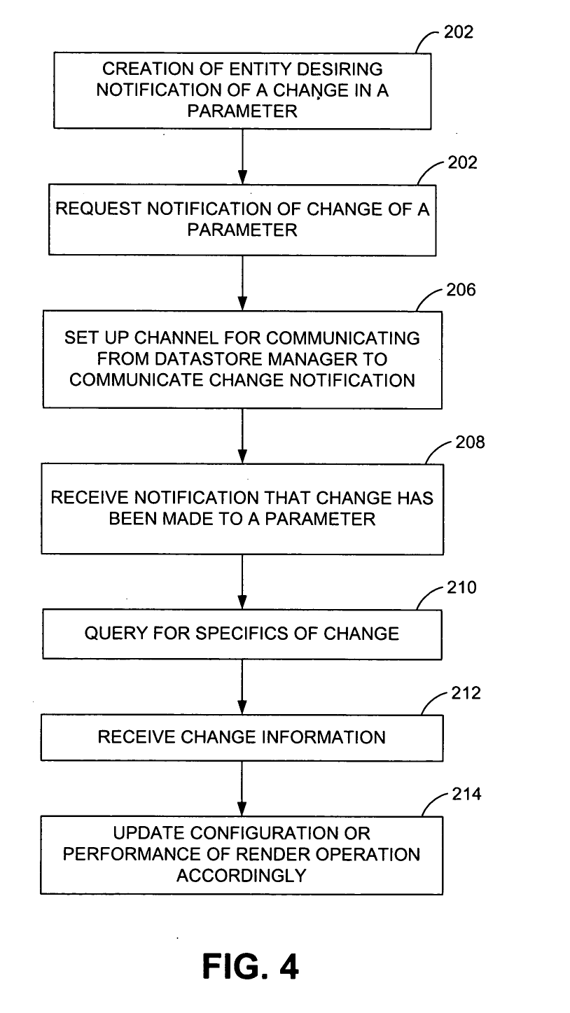

Reference is now made to FIG. 4, which is a flow chart illustrating the top-level functional operation of the embodiment illustrated in FIGS. 2 and 3, in the context of a given entity that requests notification of changes to parameters affecting the rendering of a graphic image by the entity. First, in connection with the execution and operation of a render node, an entity is created, which desires notification of a change in a parameter that impacts its operation (202). Thereafter, the entity requests notification from a datastore manager of any parameter changes (204). The entity and datastore manager also cooperate to establish a channel over which the datastore manager communicates notifications to the entity of changes in a parameter (206). As mentioned above, in one embodiment such changes are communicated using a highly efficient, compact message (e.g., one byte) that be communicated (in broadcast or multicast form) to all interested entities. Each entity periodically monitors or polls its established channel until receiving notification that a change to a parameter has been made (208). The receiving entity queries the datastore manager for specifics of the change (210). In reply, the datastore manager instructs the entity of the changes that have been made (212). It should be appreciated that, in one embodiment, the communications of 210 and 212 occur over the same communication channel that was originally established between the entity and datastore manager for parameter-related communications. In another embodiment, the communications of 210 and 212 occur over a different communication channel (than the one that was originally established between the entity and datastore manager). Finally, the entity updates its configuration or performance of a given rendering operation in accordance with the changed parameter.

As noted above, in one embodiment, after receiving notification that a change has been made to one or more parameters, the receiving entity queries the datastore manager for specifics of the change. In one embodiment, the querying entity is informed of all parameters that have changed. In an alternative embodiment, the querying entity is informed of only certain parameters that are predetermined to impact the operation or configuration of the querying entity. In yet a further embodiment, the querying entity queries the master for the status of certain or specified parameters.

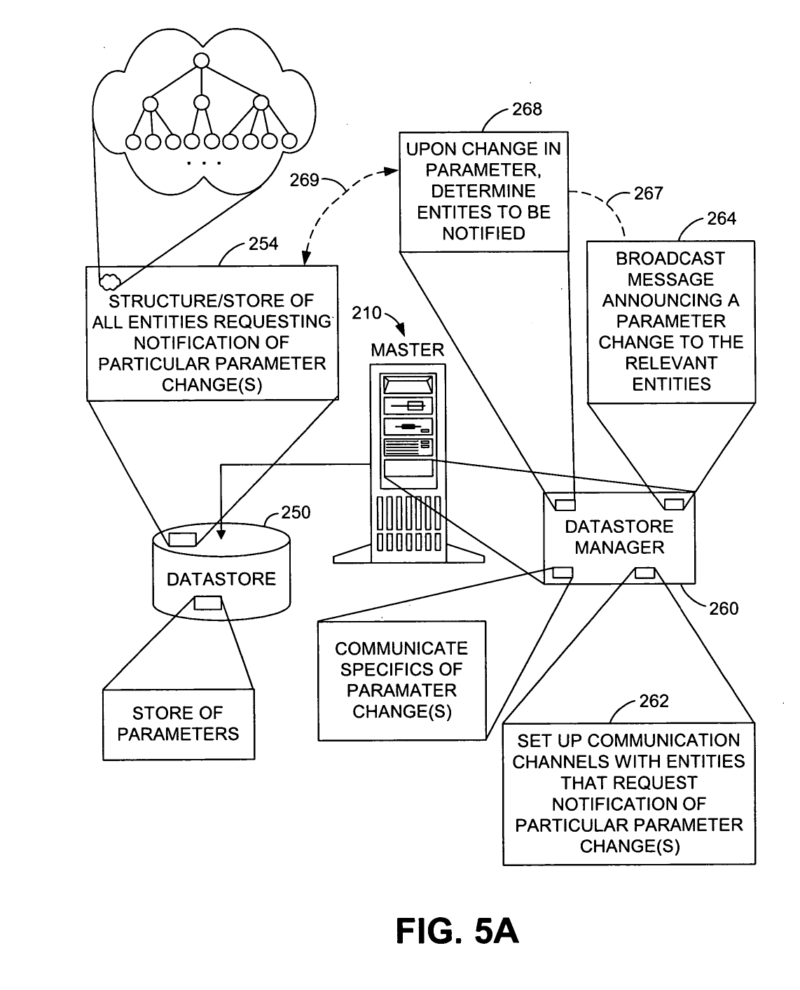

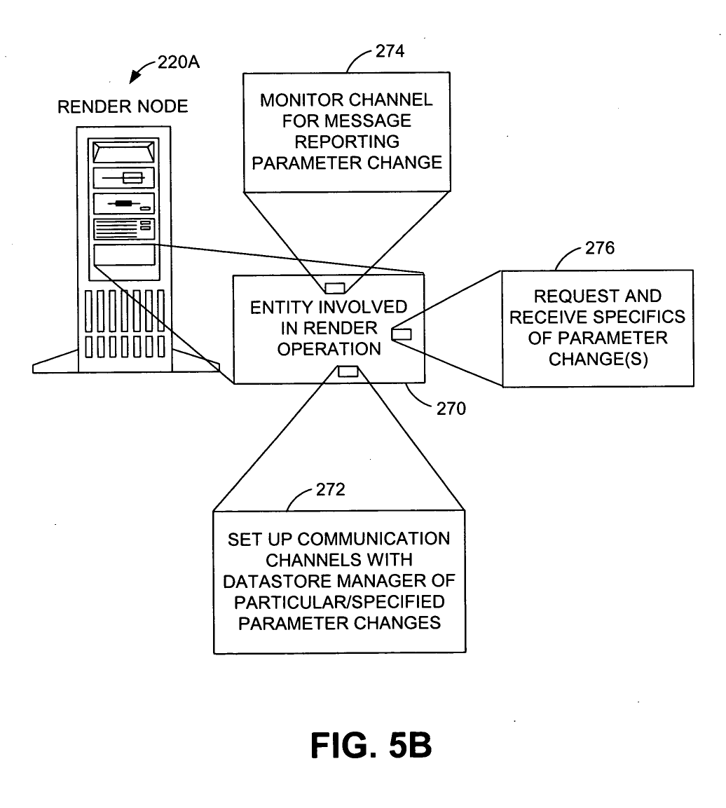

Having illustrated and described one embodiment of the present invention, reference is now made to FIGS. 5A and 5B, which illustrate an alternative embodiment of the present invention. The diagram of FIG. 5A is similar to the diagram of FIG. 2, and the diagram of FIG. 5B is similar to the diagram of FIG. 3. Therefore, the description provided in connection with FIGS. 5A and 5B is abbreviated and certain components illustrated in FIGS. 5A and 5B are not again described, as their structural or operation is similar to that of FIGS. 2 and 3. Turning first to FIG. 5A, a computer configured as a master 210 have an associated datastore 250 and datastore manager 260. The embodiment of FIGS. 5A and 5B differs from the embodiment of FIGS. 2 and 3 in that the embodiment of FIGS. 5A and 5B accommodates the request by entities to be notified of only certain parameter changes. That is, the embodiment of FIGS. 2 and 3 contemplated that any entity created, that was interested in a parameter change, receive notification from the datastore manager any time any of the parameters stored in the store parameters 152 changed. FIGS. 5A and 5B illustrate an embodiment whereby an entity registers a request to receive changes of only certain specified parameters or classes or categories of parameters. Accordingly, the data structure 254 provided in the embodiment of FIG. 5A is structured to enable ready identification, based upon a changed parameter, to determine the entities that have requested notification of such changes. Accordingly, the datastore manager 260 includes logic 268 to determine the particular entities that are to be notified of the parameter change. As illustrated by dash line 269, logic 268 cooperates or interfaces with the data structure 254. Logic 262 of FIG. 5A is similar to logic 162 of FIG. 2 except that logic 262 establishes communication channels with entities that request notification of only particular or specified parameters (or classes of parameters) within the stored parameters 252. Likewise, logic 264 broadcasts messages announcing parameter changes only to the relevant entities that have requested notification of such changes. As illustrated by dash line 267, logic 264 cooperates or communicates with logic 268.

FIG. 5B illustrates logic provided at the render node 220A. As illustrated in FIG. 3, the render node 220A includes at least one entity 270 that requests notification of certain specified changes in parameters that impact the rendering operation being performed by the entity 270. After creation of the entity 270, logic 272 establishes a communication channel with the datastore manager for notification of changes to certain specified parameters, types of parameters, categories of parameters, or classes of parameters. Thereafter, logic 274 monitors or polls the established channel for the receipt of messages reporting or broadcasting changes to the specified parameters. Logic 276 requests further identification from the datastore manager of specifics pertaining to the parameters that have been changed. Of course, the render node 220 further includes logic that modifies the otherwise conventional operation of the entity in carrying out the render operation in accordance with the new or changed parameters.

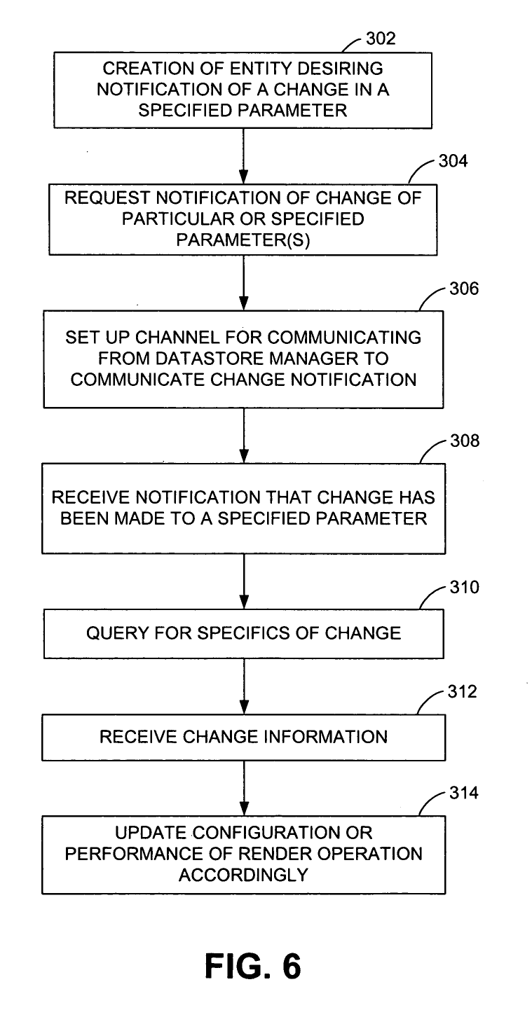

Reference is now made to FIG. 6, which is a flow chart similar to the flow chart of FIG. 4, illustrating top-level operation of the embodiment illustrated in FIGS. 5A and 5B. The illustrated operation begins with the creation of an entity desiring notification of a change in a specified parameter (302). The entity requests notification by the datastore manager, of changes of particular or specified parameters (304). Channels for communicating are established between the datastore manager and the entity, over which the datastore manager communicates change notifications to the entity (306). Upon the detection, by the datastore manager, of a change in a parameter and the determination (by the datastore manager) of the relevant entities to be notified, at least one specified entity receives notification that a change has been made to a specified parameter (308). In one embodiment, the entity queries the datastore manager for specifics regarding the parameter change (310). The entity receives information specifying the changed parameter (312), and updates its configuration or performance of rendering operation accordingly (314).

In accordance with the scope and spirit of the present invention, a variety of alternatives and embodiments may be implemented. For example, rather than merely requesting a notification that some change has been made to some parameter, after creation of a given entity, a communication channel is established between the entity and the datastore manager for the entity to receive notifications of specific parameter changes that are made. Such an embodiment eliminates the additional steps of further communication between the datastore manager and the entities regarding specifics of the parameter changes. In one embodiment, when a change is made to a given parameter, the datastore manager causes information specifying that change to be broadcast to all entities that have requested a change notification. This broadcast message includes information sufficient to specify the change that was made. Therefore, each entity receiving that broadcast message then has sufficient information to specify the change that was made; no further communications between the entities and the datastore manager need take place with respect to that change.

In yet another embodiment, upon creation of a given entity, the entity requests notification by the datastore manager of particular parameter changes that may be made. Upon a given a parameter change, the datastore manager determines which of the various entities requested notification about such a change. Once this determination is made, a broadcast message is sent to each entity having registered a request for such information. As in the previous embodiment just described, such a broadcast message includes sufficient specificity regarding the parameter change that no further communication between the datastore manager and rendering node entities need be made.

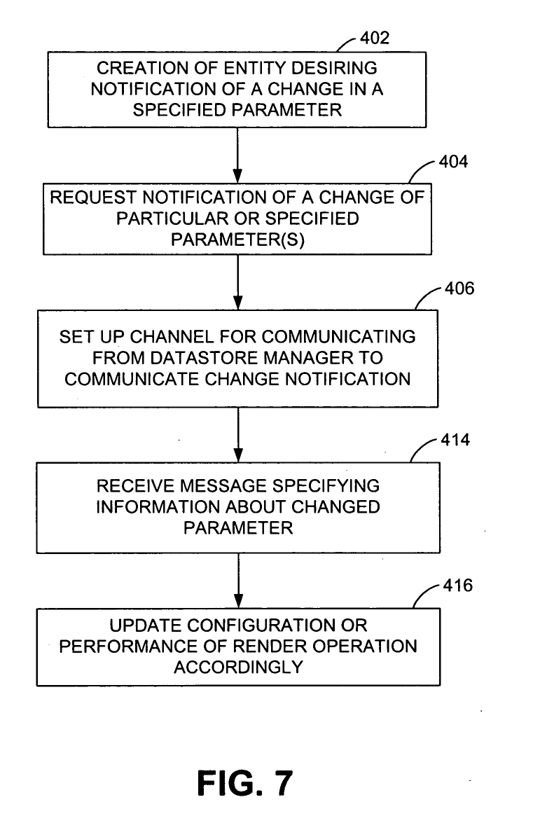

The operation of such an embodiment is illustrated in the flow chart of FIG. 7. In this embodiment, an entity is first created, which desires notification of a change in a specified parameter (402). After creation, that entity requests notification of a change of a particular or specified parameter (404). A communication channel is established between the entity and the datastore manager (406), over which information pertaining to parameter changes are communicated. A given entity receives a message specifying information about a parameter that has been changed (414). In response to the specified change, the render node updates its configuration or update the performance of its render operation accordingly (416).

Again, it will be appreciated that a variety of other embodiments, not specifically illustrated herein, may be implemented consistent with the scope and spirit of the present invention. For example, the embodiments describe above have described the collective operation of multiple processors in the rendering of computer graphics. In one embodiment, the processors may be allocated on independent computers or computer systems, such that multiple computer systems cooperate in a cluster to render a graphics image.

The foregoing has also described the communication of a message to at least one impacted or interested entity. Consistent with the scope and spirit of the invention, in one embodiment the master (or datastore manager) communicates a message to each interested or impacted entity for each parameter that is changed. In another embodiment, the master (or datastore manager) communicates to each interested or impacted entity a message embodying more than one change in a parameter. In yet another embodiment, the master (or datastore manager) communicates to each interested or impacted entity a message embodying a change in a plurality of parameters. In yet another embodiment, the message communicated to the entities includes information about all parameters that are of interest to the receiving entities. In yet another embodiment, the message communicated to the entities includes information about all parameters (including parameters that are not of particular interest to particular entities). While these various embodiments have been only summarily described above, additional details and features will be appreciated by persons skilled in the art, based on the description provided herein. In one embodiment, the master (or datastore manager) may communicate a notification regarding at least one parameter change, using for example multicast messaging, to all entities that have registered an interest with the master (or datastore manager) to be notified of such parameter change(s). In another embodiment, parameter changes may be globally broadcast to all entities.

It should be further appreciated that the parameter changes that are communicated to the entities directly impact the behavior or operation of the entities in some embodiments, while the parameter changes only indirectly impact the behavior or operation of the entities in other embodiments. In this respect, the parameter changes, of some embodiments, impact configuration changes. The behavior or operation of the entity is not impacted until the configuration changes are implemented. In this regard, an embodiment operates to modify a rendering operation in response to the changed configuration or parameter. The timing of such configuration changes may vary from embodiment to embodiment.

As described above, one embodiment of the invention involves the dynamic notification and updating of parameters among a plurality of computers or processors. In another embodiment, the communication or notification of parameter changes may be performed as or in a batch process. In such an embodiment, the notification is not made real-time, during rendering operations, but is made without having to perform static configuration updates. Certainly, other embodiments and equivalents may be implemented consistent with the scope and spirit of the invention.

In yet another embodiment, a computer-readable medium comprising program code is provided for execution by one of the processors configured to cooperatively render a graphics image. The computer-readable medium comprises logic for creating an entity that plays a role in rendering the graphics image, logic for sending a notification from the entity to remote device requesting to be notified of a change in at least one parameter that impacts the rending of the graphics image by the processor, and logic for receiving a notification from the device that the at least one parameter has been changed. In one embodiment, the remote device is a datastore manager. In another embodiment, the remote device is a process running on the master computer.

The computer-readable medium further comprises logic for ascertaining the change in the at least one changed parameter, and logic for modifying the render operation. The program code, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In one embodiment, the computer-readable medium includes logic for modifying a render operation in response a change in at least one parameter.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), a portable compact disc read-only memory (CDROM) (optical), and other types of computer-readable medium now known or later developed. In addition, the scope of the certain embodiments of the present invention includes embodying the functionality of the preferred embodiments of the present invention in logic embodied in hardware or software-configured mediums.

What is claimed is:

1. A multi-processor computer graphics system comprising:
a plurality of processors configured to collectively render a graphics image;
a datastore configured to store parameters that are used to control the rendering of the graphics image;
a datastore manager configured to manage the parameters stored in the datastore;
a plurality of entities associated with the plurality of processors, each of the plurality of entities comprising logic for communicating to the datastore manager an interest in being notified of changes to at least one of the parameters; and
logic associated with the datastore manager for notifying interested entities that a change has been made to at least one parameter stored in the datastore.

2. The system of claim 1, wherein each of the plurality of entities is one selected from the group consisting of a process and a thread.

3. The system of claim 1, wherein the logic for notifying is configured to send a broadcast message to the plurality of entities that have indicated an interest in being notified of changes to the parameters.

4. The system of claim 1, wherein each of the plurality of entities comprises logic responsive to the broadcast message to query the datastore manager as to the specific parameters that have changed.

5. The system of claim 1, wherein each of the plurality of entities comprises logic for establishing and maintaining a channel for communication with the datastore manager regarding the parameters.

6. The system of claim 5, wherein the channel for communication being dedicated to communications regarding the parameters.

7. The system of claim 1, wherein the datastore manager further comprises logic for maintaining a data structure that associates the parameters with the plurality of entities that have communicated an interest in being notified of changes to the parameters.

8. The system of claim 1, wherein logic for communicating an interest is configured to communicate an interest in any changes to any of the parameters.

9. The system of claim 1, wherein logic for communicating an interest is configured to communicate an interest in any changes to a specified parameter.

10. The system of claim 1, further comprising logic associated with the datastore manager for determining, responsive to changes in at least one of the parameters, which of the plurality of entities is interested in receiving notification of that change, and communicating a notification of the change to the determined entities.

11. The system of claim 1, further comprising a compositor configured to receive output signals from each of the plurality of processors and generate a single, composite signal for driving a display.

12. The system of claim 11, further comprising logic for receiving the composite signal and generating multiple graphic signals for driving multiple displays configured as a single logical display.

13. The system of claim 1, wherein the datastore and datastore manager are associated with a master processor among the plurality of processors.

14. The system of claim 1, wherein the datastore and datastore manager are associated with a slave processor among the plurality of processors.

15. The system of claim 1, wherein each of the plurality of processors resides on an independent computer node.

16. The system of claim 1, wherein the logic for notifying interested entities that a change has been made to at least one parameter stored in the datastore is further configured to specify changes in the at least one parameter in a single communication with the entities, wherein the single communication both notifies the entities that a parameter change has occurred and specifies the parameter change in a single communication.

17. A computer graphics system comprising:
logic distributed across a plurality of processors for collectively rendering a graphics image based on a plurality of specified parameters;
a datastore for storing the plurality of specified parameters;
logic associated with the datastore for notifying the logic distributed across the plurality of processors of a change in at least one of the parameters; and
logic associated with the logic distributed across the plurality of processors for updating a configuration of at least one processor based on the change in the at least on parameter.

18. The system of claim 17, wherein the datastore is a central datastore.

19. The system of claim 17, wherein the datastore is a distributed datastore.

20. The system of claim 17, wherein the logic distributed across the plurality of processors comprises a plurality of processes and a plurality of threads.

21. The system of claim 17, wherein the logic for notifying is configured to notify each of a plurality of processes and each of a plurality of threads that have registered a request to be notified of a change made to the parameters.

22. The system of claim 17, wherein the logic for notifying is configured to notify only a plurality of processes and only a plurality of threads that have registered a request to be notified of a change made to the parameters.

23. A method for a multi-processor computer graphics system comprising:
providing a datastore with a plurality of parameters that are to be utilized by a plurality of computer systems for collectively rendering a graphics image;
creating an entity, for execution on one of the processors, that plays a role in rendering the graphics image;
sending a notification from the entity to a datastore manager requesting to be notified of a change in at least one parameter stored on the datastore; and
sending a notification to the entity that a parameter has been changed.

24. The method of claim 23, further comprising determining that a change has been made to at least one parameter.

25. The method of claim 23, further comprising ascertaining the changed parameter.

26. The method of claim 23, further comprising modifying a rendering operation performed by the entity in response to a change in an operating configuration, based on a parameter has changed.

27. The method of claim 23, wherein the sending more specifically comprises broadcasting a message to all entities that requested a notification of a change to the database.

28. The method of claim 27, further comprising communicating between the entities that received the broadcast message and the datastore manager to ascertain, by the entities, the specific change made to the parameter.

29. A computer-readable medium comprising program code for execution by a processor configured to collectively render a graphics image comprising:
logic for creating an entity that plays a role in rendering the graphics image;
logic for sending a notification from the entity to remote device requesting to be notified of a change in at least one parameter that impacts the rendering of the graphics image by the processor; and
logic for receiving a notification from the device that the at least one parameter has been changed.

30. The computer-readable medium of claim 29, wherein the remote device is a datastore manager.

31. The computer-readable medium of claim 29, further comprising logic for ascertaining the change in the at least one changed parameter.

32. The computer-readable medium of claim 29, further comprising logic for modifying the render operation.

33. A multi-processor computer graphics system comprising:
a plurality of processors comprising a plurality of entities configured to collectively render a graphics image;
a datastore configured to store parameters that are used to control the rendering of the graphics image;
a datastore manager configured to manage the parameters stored in the datastore;
logic associated with the datastore manager and responsive to a change in at least one parameter for determining entities whose render operation is impacted by the change in the at least one parameter; and
logic associated with the datastore manager for notifying impacted entities that a change has been made to at least one parameter stored in the datastore.

34. The system of claim 33, wherein each of the plurality of entities is one selected from the group consisting of a process and a thread.

35. The system of claim 33, wherein the logic for notifying impacted entities comprises logic for implementing a multicast message that is directed to all entities that are determined to have impacted render operation.

36. The system of claim 33, wherein the logic for notifying impacted entities comprises logic for implementing a broadcast message that is directed to all entities.
